(19) United States
(12) Patent Application Publication
(10) Pub. No.: US 2026/0253171 A1
(43) Pub. Date: Aug. 27, 2026

(54) IMAGE STITCHING METHOD, GENE SEQUENCING SYSTEM, AND CORRESPONDING GENE SEQUENCER

(71) Applicants: BGI SHENZHEN, Guangdong (CN); BGI SHENZHEN CO., LTD, Guangdong (CN)

(72) Inventors: Huanlin LIU, Guangdong (CN); Mei LIU, Guangdong (CN); Zirui HUANG, Guangdong (CN); Bichao CHEN; Yan HONG, Guangdong (CN); Yuxiang LI, Guangdong (CN)

(21) Appl. No.: 18/879,349

(22) PCT Filed: Jun. 29, 2022
(86) PCT No.: PCT/CN2022/102424

§ 371 Date: Dec. 27, 2024

(51) Int. Cl. G06T 3/4038

(52) U.S. Cl. CPC G06T 3/4038; G06T 2200/32; G06T 2207/10056

(57) ABSTRACT

The present disclosure provides a method for image stitching, a gene sequencing system, a gene sequencer, a computer device, and a computer storage medium. The method comprises: obtaining multiple first images of a sample and template information about the track line or track cross of the sample; pre-stitching the multiple first images; selecting at least one second image from the multiple first images, and deriving a global template based on the template information of the sample and the pre-stitching coordinates of the second image; calculating the offset between the pre-stitching coordinates of the third image and the corresponding template coordinates of the third image in the global template, and adjusting the coordinates of the third image based on the offset, so as to stitch and generate a stitched image about the sample. The method can enable the stitched images of the microscope to reach higher accuracy and improve stitching efficiency.

### FIELD

The present disclosure relates to the technical field of image processing, and more particularly, to an image stitching method, corresponding gene sequencing system, gene sequencer, computer device, and computer storage medium.

### BACKGROUND

Gene sequencing refers to the analysis of the base sequence of specific DNA fragments, namely the arrangement of adenine (A), thymine (T), cytosine (C), and guanine (G). The above four types of bases carry four different fluorophores respectively, which emit fluorescence of different wavelengths (colors) when excited. One of the commonly used sequencing methods is to identify the type of synthesized base by recognizing the fluorescence wavelength, thereby modifying the base sequence. The second-generation sequencing technology uses a high-resolution microscopy imaging system to capture fluorescent molecular images of DNA Nanoballs (i.e. DNBs) on the collected samples (such as gene sequencing chips), and input the fluorescent molecular images to base recognition software to decode the image signal and obtain the base sequence. When using a high-power microscope to observe the obtained base sequence, only a magnified image of the local area of the observed object can be obtained. In view of this, it is usually achieved by continuously taking multiple shots to collect the optical signal of the entire sample. After data collection is completed, it is also necessary to obtain complete and high-precision global sample images, which is of great significance for identifying and analyzing problems in the future.

Existing image stitching schemes typically utilize pixel values or feature points between images to perform alignment, fusion, and other operations to complete the stitching process. However, most existing stitching methods are based on feature similarity, which leads to a lack of measurement standards and makes it difficult to achieve high accuracy.

Therefore, it is necessary to provide an improved image stitching method and corresponding gene sequencing system for stitching sample images.

### SUMMARY

The image stitching method and corresponding gene sequencing system provided by the present invention are dedicated to solving at least one of the above-mentioned problems.

In particular, according to a first aspect of the present invention, a method for image stitching is provided. The method comprises:
obtaining multiple first images of a sample and template information about the track line or track cross of the sample;
pre-stitching the multiple first images to obtain the pre-stitching coordinates of the multiple first images;
selecting at least one second image from the multiple first images based on the characteristic of track line or track cross, and deriving a global template based on the template information of the sample and the pre-stitching coordinates of the second image; and
for a third image other than the second image among the multiple first images, calculating the offset between the pre-stitching coordinates of the third image and the corresponding template coordinates of the third image in the global template, and adjusting the coordinates of the third image based on the offset, so as to stitch and generate a stitched image about the sample.

According to a second aspect of the present invention, a gene sequencing system is provided. The gene sequencing system comprises:
an image acquisition module configured to obtain multiple first images of a sample and template information about the track line or track cross of the sample;
an image pre-stitching module configured to pre-stitch the multiple first images to obtain the pre-stitching coordinates of the multiple first images;
a global template derivation module configured to select at least one second image from the multiple first images based on the characteristic of track line or track cross, and derive a global template based on the template information of the sample and the pre-stitching coordinates of the second image; and
a stitching image generation module configured to, for a third image other than the second image among the multiple first images, calculate the offset between the pre-stitching coordinates of the third image and the corresponding template coordinates of the third image in the global template, and adjust the coordinates of the third image based on the offset, so as to stitch and generate a stitched image about the sample.

According to a third aspect of the present invention, a gene sequencer is provided. The gene sequencer comprises a processor configured to implement the image stitching method as mentioned above when executing a computer program stored in a memory.

According to a fourth aspect of the present invention, a computer device is provided. The computer device comprises a memory and a processor, wherein the memory stores a computer program, and the processor is configured to implement the image stitching method as mentioned above when executing the computer program.

According to a fifth aspect of the present invention, a non-volatile computer-readable storage medium is provided. The non-volatile computer-readable storage medium stores a computer program thereon. The computer program is configured to implement the image stitching method as mentioned above when executed by a processor.

A new stitching concept is present by using the image stitching method for stitching sample images of the present invention, while novel track cross and track line detection algorithms are also provided. In particular, the image stitching method of the present invention utilizes the unique track line features of microscope images to construct an absolute reference frame based on existing common image stitching algorithms, and makes the fine tuning of the stitching results, which enables to ensure pixel level stitching accuracy, thereby meeting the requirements of business scenarios. In addition, the image stitching method of the present invention has high operational efficiency and strong anti-interference ability. With the increasing amount of data in the field of life sciences, its applicability is becoming more and more extensive, and it can become a reliable standard in the field of image stitching.

### BRIEF DESCRIPTION OF THE DRAWINGS

FIG. 1 is a flowchart of an image stitching method according to an embodiment of the present invention;

FIG. 2 is an example diagram of a single image captured by a microscope camera;

FIG. 3 is a schematic diagram of multiple images of a sample captured by a microscope camera;

FIG. 4 is a schematic diagram of the pre-stitching results during the image stitching process according to an embodiment of the present invention;

FIG. 5a is a schematic diagram of the positional relationship between two adjacent first images in the row obtained via the scanning in the horizontal direction during pre-stitching;

FIG. 5b is a schematic diagram of the positional relationship between two adjacent first images in the column obtained via the scanning in the vertical direction during pre-stitching;

FIG. 6 is a schematic diagram illustrating a global template for splicing samples according to an embodiment of the present invention; and

FIG. 7 is a schematic diagram of the construction process of a global template for splicing samples according to an embodiment of the present invention.

### DETAILED DESCRIPTION

In order to better understand the above objectives, features, and advantages of the examples of the present invention, the present invention will be described in detail below in conjunction with the accompanying drawings and specific implementations. It should be illustrated that one or more features in the various implementations of the present application can be combined with each other without conflict.

In the following description, many specific details are elaborated to facilitate a full understanding of the examples of the present invention. The described implementations are a part of the implementations of the present invention, not all of them. Based on the implementations of the present invention, all other implementations obtained by ordinary skilled persons in the art without creative labor are within the scope of protection of the examples of the present invention.

Unless otherwise defined, all technical and scientific terms used herein have the same meanings as those commonly understood by those skilled in the art belonging to the technical field of the examples of the present invention. Herein, the terms used in this specification of the present invention are only for the purpose of describing specific implementations and are not intended to limit the examples of the present invention.

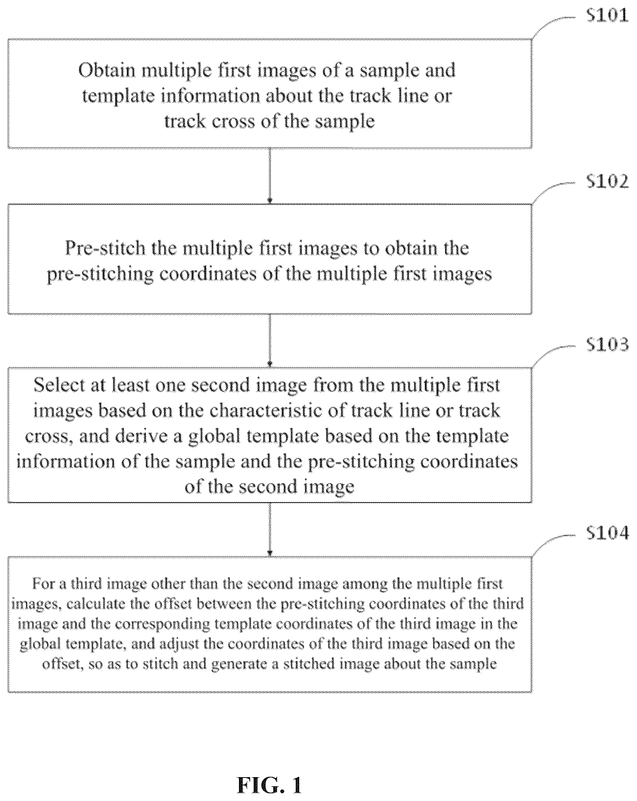

FIG. 1 is a flowchart of an image stitching method according to an embodiment of the present invention.

As shown in FIG. 1, the image stitching method may include the following steps:

S101: Obtaining multiple first images of a sample and template information about the track line (or referred to trajectory line) or track cross of the sample;

S102: Pre-stitching the multiple first images to obtain the pre-stitching coordinates of the multiple first images;

S103: Selecting at least one second image from the multiple first images based on the characteristic of track line or track cross, and deriving a global template based on the template information of the sample and the pre-stitching coordinates of the second image; and

S104: For a third image other than the second image among the multiple first images, calculating the offset between the pre-stitching coordinates of the third image and the corresponding template coordinates of the third image in the global template, and adjusting the coordinates of the third image based on the offset, so as to stitch and generate a stitched image about the sample.

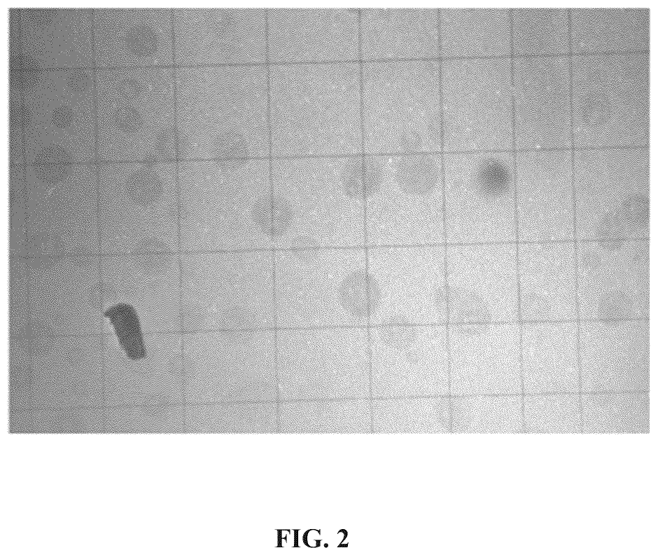

FIG. 2 is an example diagram of a single sample captured by a microscope camera.

Herein, samples can include chips, mechanical structures, precision instruments, etc. Chips can include sample chips (such as biological sample chips), computing chips, etc. Computing chips can include spatiotemporal chips, sequencing chips, and so on. Therefore, the image stitching method of the present invention is not limited to stitching images of chips, but is also applicable to stitching images of samples of various mechanical structures or precision instruments.

In one implementation scheme, for example, the sample may be a gene sequencing chip. As shown in FIG. 2, the captured image of the sample can be, for example, a fluorescence image formed by the emission of fluorophores during the sequencing process. The sample can be continuously captured using a microscope camera to obtain multiple images of various parts of the sample, which can be stitched together to form a global image of the sample as a whole or a local image of the sample. In other words, the stitched image may include the global image of the sample or the local image of the sample.

Herein, “first image” can refer to a photo of a field of view (FOV) obtained by a microscope camera making one capturing of a local part of the sample. During the sequencing process, several images can be captured sequentially for a single sample's local area. There are several track lines distributed horizontally and vertically in the image of each of the fields of view, and the intersection point of the track lines is track cross (or referred to trajectory point). Track line and track cross can be converted to each other; track cross can be obtained based on the two intersected track lines; and track line can be obtained based on collinear track crosses. The template information may include the index numbers of multiple track lines on the sample. As known to those skilled in the art, the distribution pattern of track lines on the sample is predetermined at the beginning of sample design. For example, assuming there are 10 track lines in the vertical direction of the sample, wherein their spacing can be, for example, 1, 2, 3, 4, 5, 4, 3, 2, 1, respectively. Assuming the position of the first track line is taken as the starting point (coordinate 0), the horizontal axis (x-axis) coordinates of the above 10 track lines are 0, 1, 3, 6, 10, 15, 19, 22, 24, and 25, respectively. The index numbers in the template information of the sample can be associated with the layout of the track lines on the sample. The index numbers of the 10 track lines mentioned above can be manually specified as 0, 1, 2, 3, 4, 5, 6, 7, 8, and 0, respectively.

Further, the template information of the sample obtained in step S101 may also include periodicity, for example, for the 10 track lines in the vertical direction of the above sample, they can be extended by one or more periods to the left and to the right respectively. For example, the spacing between the track lines formed by extending respective one period to the left and to the right can be 1, 2, 3, 4, 5, 4, 3, 2, 1, 1, 2, 3, 4, 5, 4, 3, 2, 1, 1, 2, 3, 4, 5, 4, 3, 2, 1 sequentially from left to right. From this, the horizontal axis (x-axis) coordinates of the expanded 28 track lines can be −25, −24, −22, −19, −15, −10, −6, −3, −1, 0, 1, 3, 6, 10, 15, 19, 22, 24, 25, 26, 28, 31, 35, 40, 44, 47, 49, 50, respectively, and their corresponding index numbers can be 0, 1, 2, 3, 4, 5, 6, 7, 8, 0, 1, 2, 3, 4, 5, 6, 7, 8, 0, 1, 2, 3, 4, 5, 6, 7, 8, 0.

It is noted that generally speaking, the index number of a sample corresponding to a certain track line is unique, and a certain index number on the sample will correspond to multiple track lines, which is determined by the periodicity of the track line design on the sample.

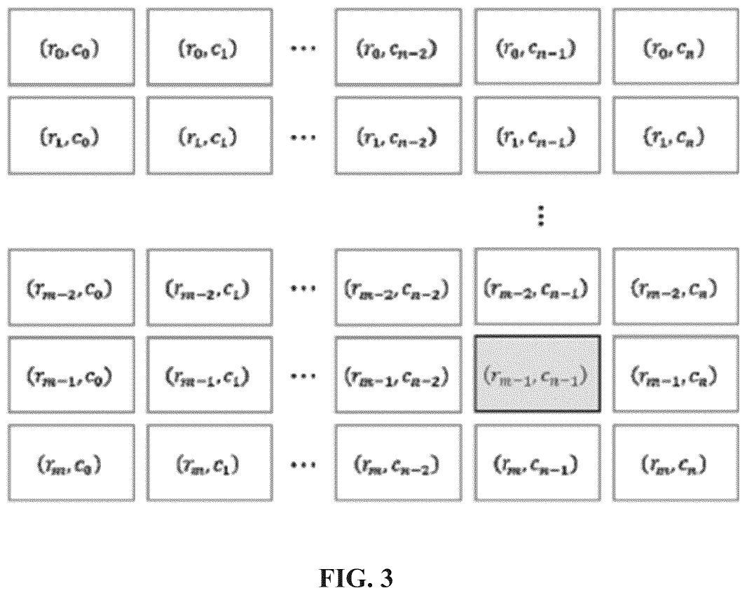

Microscopes can capture images of samples, for example, by scanning them line by line or column by column. The spatial distribution of multiple images after scanning can be shown in FIG. 3. The multiple images can include, for example, n+1 columns and m+1 rows, including the images from an image (r₀, c₀) in the first row and first column to an image (rₘ, cₙ) in the last row and last column. For the image (rₘ₋₁, cₙ₋₁) illustrated in FIG. 3, the image can have up to 8 adjacent images. In addition, the microscope can also record the camera position information when capturing the image during image capture. Subsequently, based on the camera position information recorded for any image, the corresponding position of the image can be determined and its adjacent images can be determined.

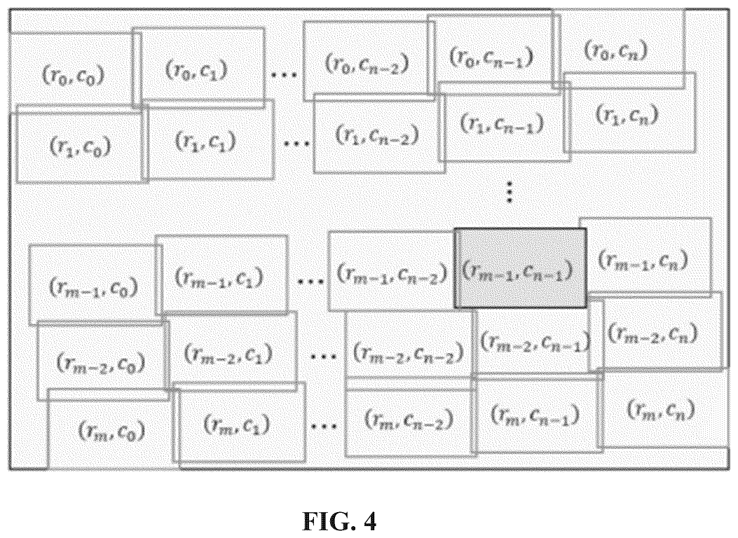

FIG. 4 is a schematic diagram of the pre-stitching results of an image stitching method according to an embodiment of the present invention.

In the pre-stitching step of S102, multiple first images can be scanned, and the left neighbor image and right neighbor image of the current first image can be determined using for example a 2-nearest neighbor method based on the scanning order or information of camera position at the time of image capture, and then the offset(s) and overlap(s) between the first image and its adjacent images on the left and right can be determined, respectively. During the scanning process, combining the template information of the sample, it is preferable to use Fast Fourier Transform (FFT) or Scale Invariant Feature Transform (SIFT) to obtain the offset(s) and overlap(s) between adjacent first images. Based on the offset(s) and overlap(s) between adjacent first images obtained during the scanning process, the pre-stitching coordinates of the multiple first images can be obtained.

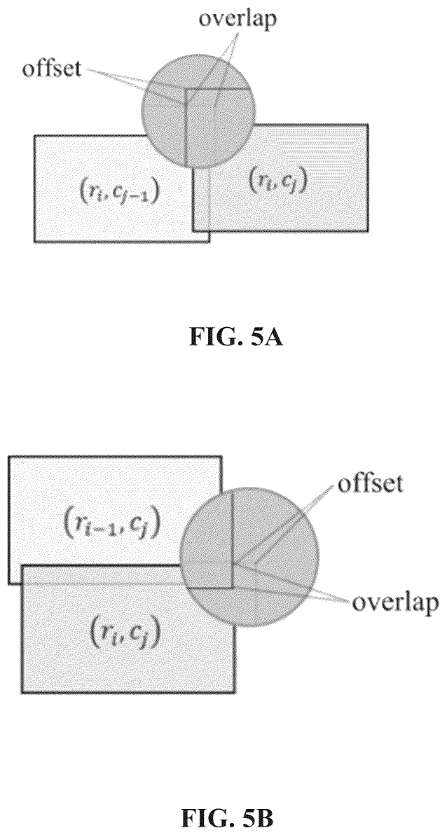

FIG. 5a is a schematic diagram of the positional relationship between two adjacent first images in the row obtained via the scanning in the horizontal direction during pre-stitching; and FIG. 5b is a schematic diagram of the positional relationship between two adjacent first images in the column obtained via the scanning in the vertical direction during pre-stitching.

Specifically, FIGS. 5a and 5b show the offset and overlap between adjacent first images obtained by scanning the first image horizontally and vertically, respectively. For horizontal scanning (with respect to FIG. 5a), the overlap distance in the horizontal direction for the obtained two adjacent images in the row is referred to the overlap in the horizontal direction, and the offset distance in the vertical direction is referred to the offset in the vertical direction. Similarly, for vertical scanning (with respect to FIG. 5b), the overlap distance in the vertical direction for the obtained two adjacent first images in the column is referred to the overlap in the vertical direction, and the offset distance in the horizontal direction is referred to the offset in the horizontal direction. After completing the horizontal and vertical scanning respectively, the offset matrix A and overlap matrix B of the multiple first images in the corresponding directions can be obtained. By using the offset matrix A and overlap matrix B, the spatial coordinates of each of the first images can be mapped, thereby completing the pre-stitching image of multiple first images as shown in FIG. 4.

However, only pre-stitching the first image cannot achieve pixel level accuracy, and thus on this basis, further precise adjustments to the coordinates of the first image need to be made in steps S103 and S104.

In step S103, the selected second image (or reference image) may be the image with the most obvious track line features among the multiple first images, or the image with the most track crosses among the multiple first images. The second image is for example the highlighted image (rₘ₋₁, cₙ₋₁) in FIGS. 3 and 4, and then the detection of the track lines for the selected image (rₘ₋₁, cₙ₋₁) can be performed. The spacing between adjacent track lines detected is matched with the spacing between track lines specified in the chip design mentioned above, and then the index number corresponding to the track line in the selected second image is determined. That is, the index number corresponding to each of the track lines in the second image can be determined based on the distance between adjacent track lines in the second image. Then, a global template can be derived based on the index number of the second image and the pre-stitching coordinates of the second image.

In one example, as shown in FIG. 2, due to the fact that the tissue slices on the sample will cover the track lines and a part of track crosses can be exposed at the position of the tissue cavity, the probability of complete track cross appearing in one image is higher than that of complete track line. Therefore, the image with the most track crosses can also be selected preferably as the second image.

In one embodiment, the index number corresponding to each of the track lines in the second image are determined based on the distance between adjacent track lines in the second image, and a global template is derived based on the index number of the second image and the pre-stitching coordinates of the second image.

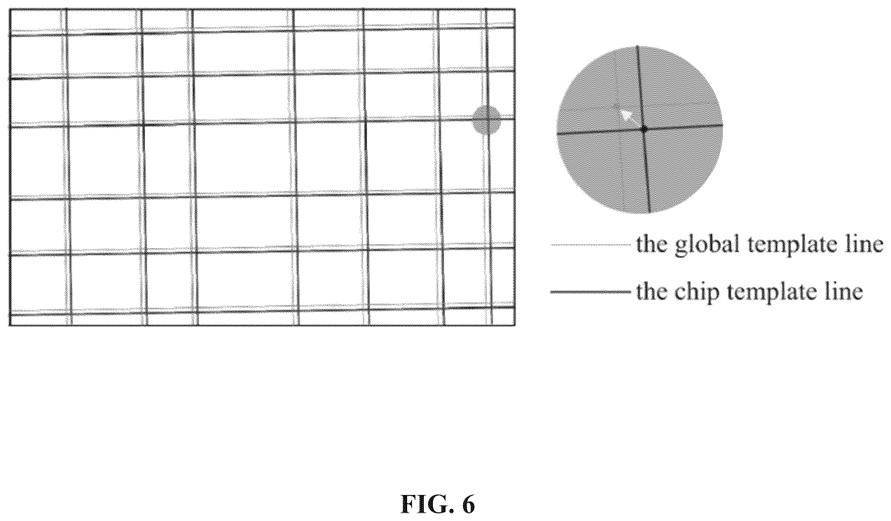

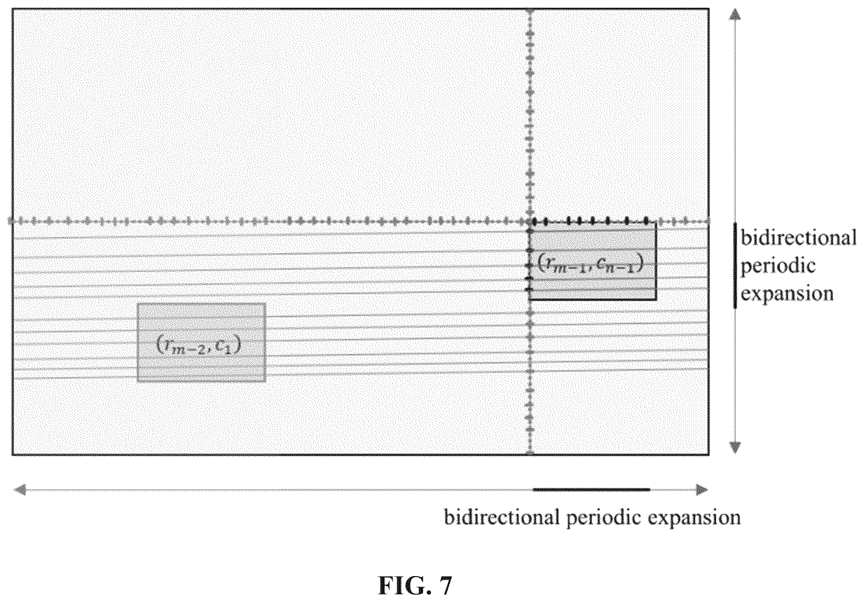

FIG. 6 is a schematic diagram illustrating a global template for splicing samples according to an embodiment of the present invention; and FIG. 7 is a schematic diagram of the construction process of a global template for splicing samples according to an embodiment of the present invention.

Referring to the construction example of the global template as shown in FIG. 7, based on the position coordinates of the selected second image (rₘ₋₁, cₙ₋₁) in the pre-stitching stage and the index number of the track line, a global template (or referred to a global reference frame) based on the second image (rₘ₋₁, cₙ₋₁) can be obtained by performing left and right bidirectional periodic expansion in the horizontal direction as well as up and down bidirectional periodic expansion in the vertical direction.

The adjustment of the coordinates of the third image other than the selected second image (rₘ₋₁, cₙ₋₁) can be divided into two categories: adjusting the coordinates of the third image containing track crosses and adjusting the coordinates of the third image without track crosses. The adjustment of the coordinates of the third image containing track crosses is achieved by adding the pre-stitching coordinates of each of the third images containing track crosses to the respective unique offset of the third images containing track crosses. The offset of the third image is a vector formed from the track cross on the third image to the template point in the global template corresponding to the track cross on the third image. Referring to the offset indicated by the arrow in the locally enlarged schematic diagram of FIG. 6, the offset represents the vector from the track cross on the sample to the template line track cross corresponding to this track cross on the derived global template.

For the determination of the unique offset, the following method can be performed preferably:
for each third image containing the track crosses, obtaining the respective offset of each of track crosses in the third image, and selecting an offset with the median angle or median distance from the offsets as the unique offset of the third image; or,
for each third image containing the track crosses, obtaining the respective offset of each of track crosses in the third image, sorting the offsets based on the vector length of the offsets, and selecting an offset at the preset sorting position as the unique offset of the third image.

By adding the unique offset of each of the third images containing track crosses to the respective unique offset of the third images containing track crosses, the adjusted coordinates of the third images containing track crosses can be obtained.

The adjustment of the coordinates of the third image without track crosses can be achieved by using a nearest neighbor adjustment method, wherein the nearest neighbor adjustment method comprises: for each third image without track crosses, adjusting the coordinates of the third image without track crosses based on the unique offset of a third image containing track crosses, as well as based on the offset and overlap between the third image without track crosses and the third image containing track crosses; wherein the third image containing track crosses is closest to the third image without track crosses.

In particular, due to issues such as tissue coverage, contamination of chip features, and the capturing quality of the microscope camera, there are some images without track crosses thereon. In this case, the third image without track crosses can be aligned based on the offset and overlap between itself and the adjacent third image containing track crosses or between itself and the nearest third image containing track crosses, wherein the third image containing track crosses refers to the adjusted image. It should be illustrated that the measure of the nearest distance is Manhattan distance, not Euclidean distance.

The adjustment of the coordinates of third image further comprises performing seam fusion processing between adjacent third images, for example, linear weighted fusion method can be used.

According to another aspect of the present invention, a gene sequencing system is also provided, characterized in that, the gene sequencing system comprises:
an image acquisition module configured to obtain multiple first images of a sample and template information about the track line or track cross of the sample;
an image pre-stitching module configured to pre-stitch the multiple first images to obtain the pre-stitching coordinates of the multiple first images;
a global template derivation module configured to select at least one second image from the multiple first images based on the characteristic of track line or track cross, and derive a global template based on the template information of the sample and the pre-stitching coordinates of the second image; and
a stitching image generation module configured to, for a third image other than the second image among the multiple first images, calculate the offset between the pre-stitching coordinates of the third image and the corresponding template coordinates of the third image in the global template, and adjust the coordinates of the third image based on the offset, so as to stitch and generate a stitched image about the sample.

In an example, the offset of the third image is a vector formed from the track cross on the third image to the template point corresponding to the track cross on the third image in the global template.

In an example, the stitching image generation module is further configured to adjust the coordinates of the third image containing track crosses by adding the pre-stitching coordinates of each third image containing track crosses to the respective unique offset for the third image containing track crosses.

In an example, the stitching image generation module is further configured to obtain the unique offset by:
for each third image containing the track crosses, obtaining the respective offset of each of track crosses in the third image, and selecting an offset with the median angle or median distance from the offsets as the unique offset of the third image; or,
for each third image containing the track crosses, obtaining the respective offset of each of track crosses in the third image, sorting the offsets based on the vector length of the offsets, and selecting an offset at the preset sorting position as the unique offset of the third image.

In an example, the stitching image generation module is further configured to use a nearest neighbor adjustment method to adjust the coordinates of third image without track crosses, wherein the nearest neighbor adjustment method comprises:
for each third image without track crosses, adjusting the coordinates of the third image without track crosses based on the unique offset of a third image containing track crosses, as well as based on the offset and overlap between the third image without track crosses and the third image containing track crosses; wherein the third image containing track crosses is closest to the third image without track crosses.

The features mentioned in the above descriptions of various examples of image stitching methods can also be extended and applied to the gene sequencing system herein and the gene sequencer below. For the sake of simplicity, further elaboration is not provided here.

The present invention also provides a gene sequencer, characterized in that, the gene sequencer comprises a processor configured to implement any one of the image stitching methods for stitching the image of the sample described above when executing a computer program stored in a memory. It should be illustrated that the gene sequencer may include a chip platform, an optical system, and a liquid pathway system. Among them, the chip platform can be used to load samples, the optical system can be used to acquire images, and the liquid pathway system can be used to perform biochemical reactions using preset reagents. The processor is also used to execute the image stitching method and various software, such as operating systems and application display software, installed in the gene sequencer. A processor includes but is not limited to a Central Processing Unit (CPU), a Micro Controller Unit (MCU), and other devices used to interpret computer instructions and process data in computer software.

The gene sequencer can also comprise a display screen and a memory. The memory and display screen can be electrically connected to the processor, respectively. The display screen is installed on the gene sequencer for displaying information. The memory can be different types of storage devices for storing various types of data. For example, it can be the storage or memory (which here can be referred to internal storage) of a gene sequencer, or it can be a storage card that can be externally connected to the gene sequencer, such as flash memory, Smart Media (SM) Card, Secure Digital (SD) Card, etc. Moreover, the memory may include high-speed random access memory, as well as non-volatile memory such as hard disk, memory, plug-in hard disk, smart storage card, Secure Digital (SD) Card, Flash Card, at least one disk storage device, flash device, or other volatile solid-state storage devices. Memory is used to store various types of data, such as various applications installed in the gene sequencer, data set and obtained by applying the above image stitching methods, and other information.

The present invention also provides a computer device comprising a memory and a processor, wherein the memory stores a computer program, and the processor is configured to implement any one of the image stitching methods described above when executing the computer program.

The present invention also provides a non-volatile computer-readable storage medium on which a computer program is stored, characterized in that, the computer program, when executed by a processor, implements any one of the image stitching methods described above.

If the integrated modules/units of the gene sequencing system/gene sequencer/computer device are implemented in the form of software functional units and sold or used as independent products, they can be stored in a computer-readable storage medium. Based on this understanding, implementing, by the present invention, all or part of the processes in the above implementation methods can also be completed by instructing relevant hardware through a computer program. The computer program can be stored in a computer-readable storage medium, and when executed by a processor, this computer program can implement the steps of example(s) for each of the methods described above. Among them, the computer program includes computer program code, which can be source code form, object code form, executable file, or some intermediate form, etc. The computer-readable storage medium may include any entity or apparatus capable of carrying the computer program code, a recording medium, USB flash disk, mobile hard disk, magnetic disk, optical disk, computer memory, Read-Only Memory (ROM), Random Access Memory (RAM), Electric carrier signal, telecommunications signal, and software distribution media, etc.

The processor can be a central processing unit (CPU), and also can be other general-purpose processors, digital signal processors (DSP), Application Specific Integrated Circuit (ASIC), Field Programmable Gate Array (FPGA), or other programmable logic devices, discrete gates or transistor logic devices, discrete hardware components, etc. A general-purpose processor can be a microprocessor or any conventional processor, etc. The processor is the control center of the gene sequencing system/gene sequencer, and utilizes various interfaces and lines to connect the various parts of the entire gene sequencing system/gene sequencer.

The memory is used to store the computer programs and/or modules, and the processor realizes various functions of the gene sequencing system/gene sequencer by running or executing the computer programs and/or modules stored in the memory as well as calling the data stored in the memory. The memory may mainly include a storage program area and a storage data area, wherein the storage program area may store an operating system, at least one application required for a function, etc.

In the several specific implementations provided by the present invention, it should be understood that the disclosed method can be implemented in other ways. For example, the system implementation described above is only illustrative. For example, the division of modules is only a logical function division, and there may be other division methods in actual implementation.

For those skilled in the art, it is apparent that the examples of the present invention are not limited to the details of the exemplary examples described above, and can be implemented in other specific forms without departing from the spirit or basic features of the examples of the present invention. Therefore, from any point of view, the examples should be regarded as exemplary and non-limiting. The scope of the examples of the present invention is limited by the appended claims rather than the above description. Therefore, it is intended to cover all variations falling within the meaning and scope of the equivalent elements of the claims within the examples of the present invention. Any reference numerals in the claims should not be regarded as limiting the claims involved. Multiple units, modules, or apparatus stated in the system, apparatus, or terminal claims may also be implemented by the same unit, module, or apparatus through software or hardware.

The above implementations are only used to illustrate the technical solutions of the examples of the present invention and not to limit them. Although the examples of the present invention have been described in detail with reference to the preferred implementations above, those skilled in the art should understand that modifications or equivalent substitutions to the technical solutions of the examples of the present invention should not depart from the spirit and scope of the technical solutions of the examples of the present invention.

What is claimed is:

1. A method for image stitching, characterized in that, the method comprises:
obtaining multiple first images of a sample and template information about the track line or track cross of the sample;
pre-stitching the multiple first images to obtain the pre-stitching coordinates of the multiple first images;
selecting at least one second image from the multiple first images based on the characteristic of track line or track cross, and deriving a global template based on the template information of the sample and the pre-stitching coordinates of the second image; and
for a third image other than the second image among the multiple first images, calculating the offset between the pre-stitching coordinates of the third image and the corresponding template coordinates of the third image in the global template, and adjusting the coordinates of the third image based on the offset to stitch and generate a stitched image about the sample.

2. The image stitching method according to claim 1, characterized in that, said pre-stitching the multiple first images to obtain the pre-stitching coordinates of the multiple first images comprises:
scanning the multiple first images and obtaining the pre-stitching coordinates of the multiple first images based on the offset and overlap between adjacent first images obtained during the scanning process.

3. The image stitching method according to claim 2, characterized in that, the offset and overlap between adjacent first images obtained are obtained by scanning multiple first images using Fast Fourier Transform or Scale Invariant Feature Transform.

4. The image stitching method according to claim 1, characterized in that, the second image is the image with the most obvious track line features or the image with the most track crosses among the multiple first images.

5. The image stitching method according to claim 1, characterized in that, the template information comprises index numbers of multiple track lines on the sample, and said deriving a global template based on the template information of the sample and the pre-stitching coordinates of the second image comprises:
determining the index numbers corresponding to each track line in the second image based on the distance between adjacent track lines in the second image, and deriving the global template based on the index numbers of the second image and pre-stitching coordinates of the second image.

6. The image stitching method according to claim 4, characterized in that, the template information comprises index numbers of multiple track lines on the sample, and said deriving a global template based on the template information of the sample and the pre-stitching coordinates of the second image comprises:
determining the index numbers corresponding to each track line in the second image based on the distance between adjacent track lines in the second image, and deriving the global template based on the index numbers of the second image and pre-stitching coordinates of the second image.

7. The image stitching method according to claim 1, characterized in that, the offset of the third image is a vector formed by the track cross on the third image pointing to the template point in the global template corresponding to the track cross on the third image.

8. The image stitching method according to claim 1, characterized in that said adjusting the coordinates of the third image comprises adjusting the coordinates of the third image containing track crosses in a manner of adding the pre-stitching coordinates of each third image containing track crosses to the respective unique offset for the third image containing track crosses.

9. The image stitching method according to claim 8, characterized in that, the unique offset is obtained in a manner of:
obtaining the respective offset of each of track crosses in the third image containing the track crosses, and for each third image selecting an offset with the median angle or median distance from the offsets as the unique offset of the third image; or,
obtaining the respective offset of each of track crosses in the third image containing the track crosses, sorting the offsets based on the vector length of the offsets, and selecting an offset at the preset sorting position as the unique offset of the third image.

10. The image stitching method according to claim 9, characterized in that, said adjusting the coordinates of the third image based on the offset further comprises using a nearest neighbor adjustment method to adjust the coordinates of third image without track crosses, wherein the nearest neighbor adjustment method comprises:
for each third image without track crosses, adjusting the coordinates of the third image without track crosses based on the unique offset of a third image containing track crosses which is closest to the third image without track cross, as well as based on the offset and overlap between the third image without track crosses and the closest third image containing track crosses.

11. The image stitching method according to claim 1, characterized in that, said adjusting the coordinates of the third image further comprises performing seam fusion processing between adjacent third images.

12. A gene sequencing system, characterized in that, the gene sequencing system comprises:
an image acquisition module configured to obtain multiple first images of a sample and template information about the track line or track cross of the sample;
an image pre-stitching module configured to pre-stitch the multiple first images to obtain the pre-stitching coordinates of the multiple first images;
a global template derivation module configured to select at least one second image from the multiple first images based on the characteristic of track line or track cross, and derive a global template based on the template information of the sample and the pre-stitching coordinates of the second image; and
a stitching image generation module configured to, for a third image other than the second image among the multiple first images, calculate the offset between the pre-stitching coordinates of the third image and the corresponding template coordinates of the third image in the global template, and adjust the coordinates of the third image based on the offset to stitch and generate a stitched image about the sample.

13. The gene sequencing system according to claim 12, characterized in that, the offset of the third image is a vector formed by the track cross on the third image pointing to the template point in the global template corresponding to the track cross on the third image.

14. The gene sequencing system according to claim 12, characterized in that, the stitching image generation module is further configured to adjust the coordinates of the third image containing track crosses in a manner of adding the pre-stitching coordinates of each third image containing track crosses to the respective unique offset for the third image containing track crosses.

15. The gene sequencing system according to claim 14, characterized in that, the stitching image generation module is further configured to obtain the unique offset in a manner of:
obtaining the respective offset of each of track crosses in the third image containing the track crosses, and for each third image, selecting an offset with the median angle or median distance from the offsets as the unique offset of the third image; or,
obtaining the respective offset of each of track crosses in the third image containing the track crosses, sorting the offsets based on the vector length of the offsets, and selecting an offset at the preset sorting position as the unique offset of the third image.

16. The gene sequencing system according to claim 12, characterized in that, the stitching image generation module is further configured to use a nearest neighbor adjustment method to adjust the coordinates of third image without track crosses, wherein the nearest neighbor adjustment method comprises:
for each third image without track crosses, adjusting the coordinates of the third image without track crosses based on the unique offset of a third image containing track crosses which is closest to the third image without track crosses, as well as based on the offset and overlap between the third image without track crosses and the closest third image containing track crosses.

17. A computer device, characterized in that, comprising a memory and a processor, wherein the memory stores a computer program, and the processor is configured to implement the image stitching method according to any one of claims 1-11 when executing the computer program.
